(19) United States
(12) Patent Application Publication
(10) Pub. No.: US 2024/0144510 A1
(43) Pub. Date: May 2, 2024

(54) PHYSIQUE DETERMINATION DEVICE AND PHYSIQUE DETERMINATION METHOD

(71) Applicant: Mitsubishi Electric Corporation, Tokyo (JP)

(72) Inventors: Atsuhiro YAMADA, Tokyo (JP); Takumi TAKEI, Tokyo (JP)

(73) Assignee: Mitsubishi Electric Corporation, Tokyo (JP)

(21) Appl. No.: 18/279,260

(22) PCT Filed: Apr. 15, 2021
(86) PCT No.: PCT/JP2021/015586

§ 371 Date: Aug. 29, 2023

(51) Int. Cl. G06T 7/60; G06F 16/583

(52) U.S. Cl. CPC G06T 7/60; G06F 16/5854; G06T 2207/30196

(57) ABSTRACT

A physique determination device includes: an acquisition unit to acquire an image of a person; a detection unit to detect, from the acquired image, at least one of a plurality of physical feature points of the person; a determination unit to determine, on the basis of the at least one physical feature point that has been detected, a physique of the person; and a calculation unit to calculate, on the basis of the at least one physical feature point that has been detected, a degree of reliability of the determined physique of the person.

### TECHNICAL FIELD

The present disclosure relates to a physique determination device and a physique determination method.

### BACKGROUND ART

The interior monitoring device described in Patent Literature 1, which is an example of a physique determination device, estimates the physique of an occupant in a vehicle on the basis of both an image obtained by capturing the occupant and an estimated posture in order to reduce deterioration in accuracy of the estimation due to a change in posture of the occupant or the like.

### CITATION LIST

### Patent Literatures

Patent Literature 1: JP 2020-104680 A

### SUMMARY OF INVENTION

### Technical Problem

However, the interior monitoring device can estimate the physique of the occupant, whereas it cannot indicate how reliable the estimated physique of the occupant is.

An object of the present disclosure is to provide a physique determination device that estimates the physique of a person and indicates a degree of reliability of the estimation.

### Solution to Problem

In order to address the above problem, the physique determination device according to the present disclosure includes: an acquisition unit to perform acquisition of an image of a person; a detection unit to perform detection, from the image that is acquired, of at least one of a plurality of physical feature points of the person; a determination unit to perform determination, on a basis of the at least one of the plurality of physical feature points that is detected, of a physique of the person; and a calculation unit to perform calculation, on a basis of the at least one of the plurality of physical feature points that is detected, of a degree of reliability of the physique of the person that is determined.

### Advantageous Effects of Invention

The physique determination device according to the present disclosure can estimate the physique of a person, and further, can indicate a degree of reliability of the estimation.

### BRIEF DESCRIPTION OF DRAWINGS

FIG. 1 is a functional block diagram of a physique determination device 10 according to a first embodiment.

FIG. 2 is a diagram illustrating an image GZ of the interior of a vehicle according to the first embodiment.

FIG. 3 is a diagram illustrating a configuration of the physique determination device 10 according to the first embodiment.

FIG. 4 is a flowchart illustrating an operation of the physique determination device 10 according to the first embodiment.

FIG. 5A is a diagram illustrating a degree of physique reliability TS (an example of using the number: degree of physique reliability TS=100%) in the first embodiment. FIG. 5B is a diagram illustrating the degree of physique reliability TS (example of using the number: degree of physique reliability TS=71%) in the first embodiment.

FIG. 6A is a diagram illustrating the degree of physique reliability TS (example of using a part: degree of physique reliability TS=100%) in the first embodiment. FIG. 6B is a diagram illustrating the degree of physique reliability TS (example of using a part: degree of physique reliability TS=80%) in the first embodiment.

FIG. 7A is a diagram illustrating the degree of physique reliability TS (an example of using position: degree of physique reliability TS=100%) in the first embodiment. FIG. 7B is a diagram illustrating the degree of physique reliability TS (example of using position: physique reliability TS=57%) in the first embodiment.

FIG. 8A is a diagram illustrating the degree of physique reliability TS (an example of using a degree of certainty: degree of physique reliability TS=100%) of a person HT in the first embodiment. FIG. 8B is a diagram illustrating the degree of physique reliability TS (example of using a degree of certainty: physique reliability TS=86%) of the person HT in the first embodiment.

FIG. 9 is a flowchart illustrating an operation of the physique determination device 10 according to a first modification of the first embodiment.

FIG. 10 is a diagram illustrating person information HJ according to a second embodiment.

FIG. 11 is a functional block diagram of a physique determination device 20 according to the second embodiment.

FIG. 12 is a diagram illustrating a history of the person information HJ according to the second embodiment.

FIG. 13 is a flowchart (main routine) illustrating an operation of the physique determination device 20 according to the second embodiment.

FIG. 14 is a flowchart (sub routine) illustrating the operation of the physique determination device 20 according to the second embodiment.

FIG. 15 is a diagram illustrating personal feature information HTJ according to a third embodiment.

FIG. 16 is a functional block diagram of a physique determination device 30 according to the third embodiment.

FIG. 17 is a flowchart illustrating an operation of the physique determination device 30 according to the third embodiment.

### DESCRIPTION OF EMBODIMENTS

Embodiments of a physique determination device according to the present disclosure will be described.

### First Embodiment

### First Embodiment

<Function of First Embodiment>

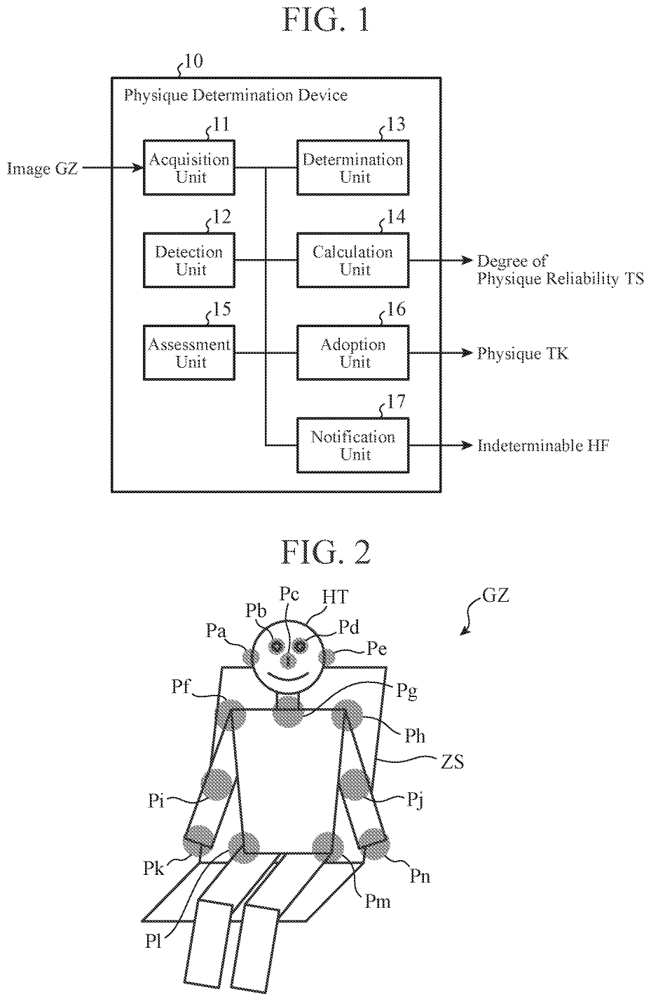

FIG. 1 is a functional block diagram of a physique determination device 10 according to a first embodiment. The function of a physique determination device 10 according to the first embodiment will be described below with reference to FIG. 1.

As illustrated in FIG. 1, the physique determination device 10 includes an acquisition unit 11, a detection unit 12, a determination unit 13, a calculation unit 14, an assessment unit 15, an adoption unit 16, and a notification unit 17 in order to determine a physique TK of a person HT on the basis of an image GZ (illustrated in FIG. 2, for example) of the interior of a vehicle such as an automobile in which the person HT is seated on a seat ZS, and to calculate a degree of reliability TS (hereinafter referred to as “degree of physique reliability”) indicating how reliable the physique TK of the person HT is.

The term “physique” collectively refers to appearance, body shape, physicality, body type, and the like. The “physique” is represented by, for example, “tall and slightly thin”, “slightly short and fat”, or the like.

The acquisition unit 11 corresponds to an “acquisition unit”, the detection unit 12 corresponds to a “detection unit”, the determination unit 13 corresponds to a “determination unit”, the calculation unit 14 corresponds to a “calculation unit”, the assessment unit 15 corresponds to an “assessment unit”, the adoption unit 16 corresponds to an “adoption unit”, and the notification unit 17 corresponds to a “notification unit”.

FIG. 2 illustrates the image GZ of the interior of the vehicle according to the first embodiment.

As illustrated in FIG. 2, the image GZ of the interior of the vehicle is, for example, an image obtained by capturing mainly substantially the upper body of the person HT riding in the automobile. The image GZ virtually includes a plurality of physical feature points representing the physique TK of the person HT, for example, physical feature points Pa to Pn.

In the following, the physical feature points Pa to Pn and the like may be collectively referred to as a physical feature point P in order to facilitate description and understanding.

Returning to FIG. 1, the physique determination device 10 will be described.

The acquisition unit 11 acquires the image GZ of the interior of the vehicle in which the person HT rides.

The detection unit 12 detects at least one of the plurality of physical feature points Pa to Pn of the person HT from the image GZ using a conventionally known method.

The determination unit 13 determines the physique TK of the person HT by a conventionally known method on the basis of the at least one of the detected physical feature points, for example, the physical feature points Pf, Pg, Ph, and the like.

The calculation unit 14 calculates the above-described degree of physique reliability TS on the basis of the at least one detected physical feature point, for example, the above-described physical feature point Pf, Pg, Ph, or the like.

The assessment unit 15 performs assessment over the entire physique determination device 10. For example, the assessment unit 15 assesses whether or not the degree of physique reliability TS calculated by the calculation unit 14 exceeds a predetermined threshold (hereinafter referred to as a “physique reliability threshold TSS”) (see FIG. 9) for the degree of physique reliability TS by repeating the acquisition by the acquisition unit 11, the detection by the detection unit 12, the determination by the determination unit 13, and the calculation by the calculation unit 14. The physique reliability threshold TSS is a numerical value specified from experiments, implementations, and the like, and is, for example, 80%, 85%, or the like.

Instead of the assessment described above, the assessment unit 15 may use, for example, a result of inference obtained from machine learning by inputting at least one of the number, the part, the position, or the degree of certainty of the at least one detected physical feature point.

The first embodiment and other embodiments are based on the premise that the physique reliability threshold TSS is set to “80%”.

The physique reliability threshold corresponds to a “predetermined reliability threshold”.

The adoption unit 16 adopts the physique TK when the degree of physique reliability TS is assessed to exceed the physique reliability threshold TSS by the repetition described above.

When it is assessed that the degree of physique reliability TS does not exceed the physique reliability threshold TSS, the notification unit 17 gives a notification indicating “indeterminable” (HF). Here, the “indeterminable (HF)” means a fact that the physique TK cannot be determined and an instruction of an action to be performed by the person HT in order to increase the degree of physique reliability TS, for example, an instruction indicating that the person HT should properly sit on the seat ZS.

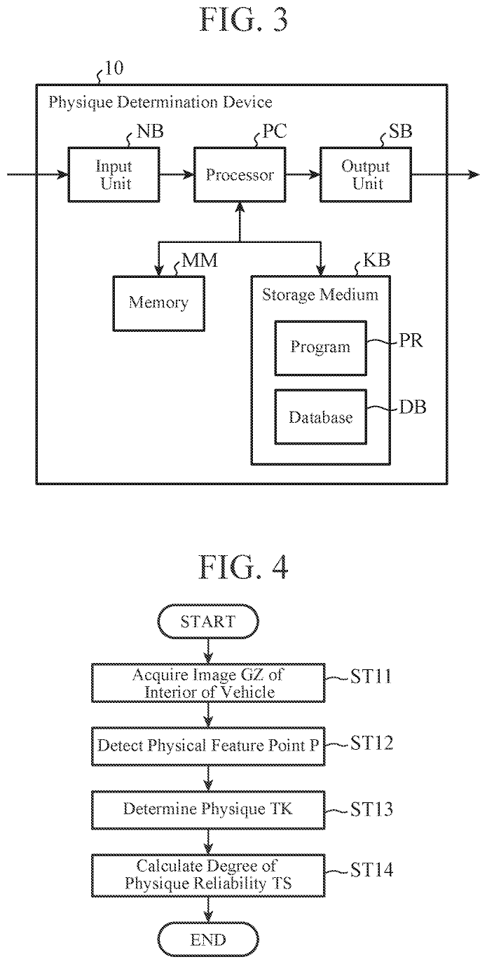

FIG. 3 is a diagram illustrating the configuration of the physique determination device 10 according to the first embodiment.

The physique determination device 10 according to the first embodiment includes an input unit NB, a processor PC, an output unit SB, a storage medium KB, and a memory MINI as illustrated in FIG. 3 in order to achieve the above-described functions.

The input unit NB includes, for example, a camera, a microphone, a keyboard, a mouse, and a touch panel. The processor PC is a core of a well-known computer that operates hardware in accordance with software. The output unit SB includes, for example, a liquid crystal monitor, a printer, and a touch panel. The memory MM includes, for example, a dynamic random access memory (DRAM) and a static random access memory (SRAM). The storage medium KB includes, for example, a hard disk drive (HDD), a solid state drive (SSD), and a read only memory (ROM).

The storage medium KB stores a program PR and a database DB. The program PR is a command group that defines the details of processing to be executed by the processor PC. The database DB includes, for example, an acquired image GZ (illustrated in FIG. 2), a detected physical feature point P (illustrated in FIG. 2), a determined physique TK, and a calculated degree of physique reliability TS (not illustrated).

Regarding the relationship between the functions and the configuration of the physique determination device 10, the processor PC executes, using the hardware, the program PR stored in the storage medium KB on the memory MM and controls the operations of the input unit NB and the output unit SB as necessary, thereby implementing the functions of the units including the units from the acquisition unit 11 to the notification unit 17.

<Operation of First Embodiment>

FIG. 4 is a flowchart illustrating an operation of the physique determination device 10 according to the first embodiment.

The operation of the physique determination device 10 according to the first embodiment will be described below with reference to the flowchart of FIG. 4.

Step ST11: The processor PC (illustrated in FIG. 3) acquires, as the acquisition unit 11 (illustrated in FIG. 1), the image GZ (illustrated in FIG. 2) of the interior of the vehicle such as an automobile in which the person HT is seated on the seat ZS.

Step ST12: The processor PC detects, as the detection unit 12 (illustrated in FIG. 1), the physical feature point P from the acquired image GZ using a conventionally known method.

Step ST13: The processor PC determines, as the determination unit 13 (illustrated in FIG. 1), the physique TK of the person HT by a conventionally known method on the basis of the detected physical feature point P.

Step ST14: The processor PC calculates, as the calculation unit 14 (illustrated in FIG. 1), the degree of physique reliability TS of the person HT whose physique TK has been determined by the determination unit 13 on the basis of at least one of the number, part, position, or degree of certainty of the detected physical feature point P.

The “degree of certainty” of the physical feature point P indicates how certain the physical feature point P is.

### Example of Calculation of Degree of Physique Reliability TS

In the following description of the calculation of the degree of physique reliability TS, seven physical feature points P1 to P7 are used instead of the physical feature points Pa to Pn (illustrated in FIG. 2) in order to facilitate the description and understanding.

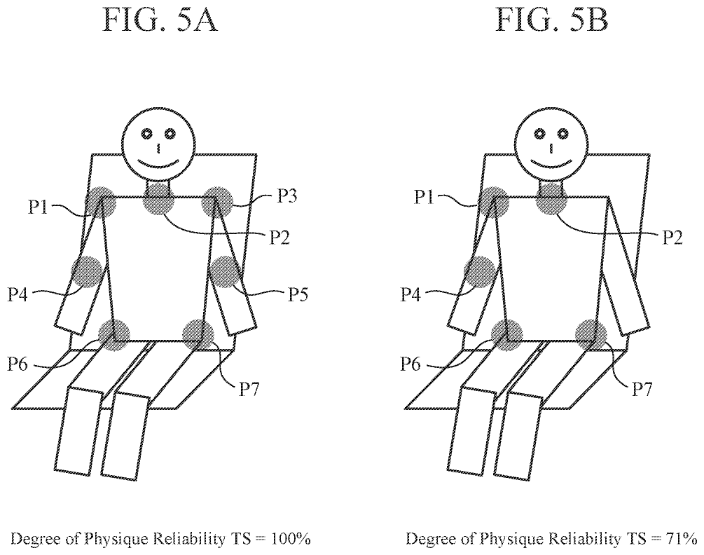

FIG. 5A illustrates the degree of physique reliability TS (example of using the number: degree of physique reliability TS=100%) in the first embodiment.

FIG. 5B illustrates the degree of physique reliability TS (example of using the number: degree of physique reliability TS=71%) in the first embodiment.

As illustrated in FIG. 5A, the detection unit 12 should originally detect all of the seven physical feature points P1 to P7 from the image GZ. When the detection unit 12 detects all of the seven physical feature points P1 to P7, the calculation unit 14 calculates that the degree of physique reliability TS is 100% (=7/7).

Unlike the above, when the detection unit 12 detects, for example, five physical feature points P1, P2, P4, P6, and P7 among the seven physical feature points P1 to P7 as illustrated in FIG. 5B, the calculation unit 14 calculates that the degree of physique reliability TS of the person HT is about 71% (=5/7).

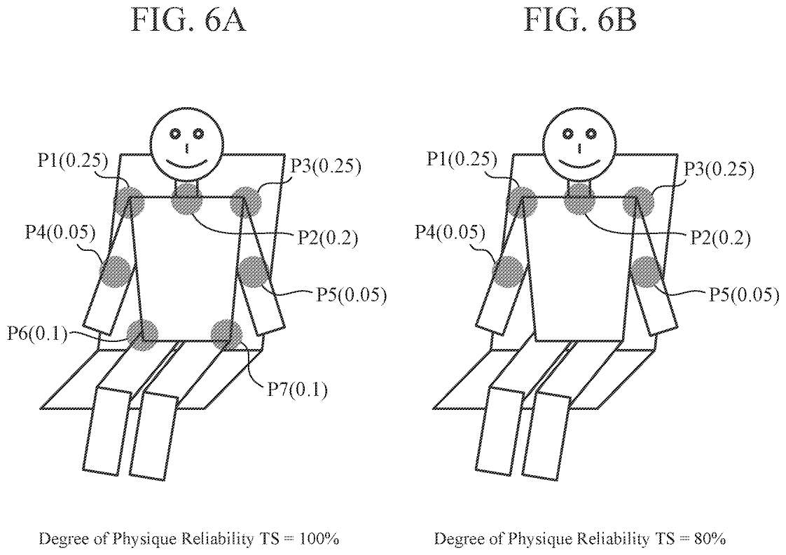

FIG. 6A illustrates the degree of physique reliability TS (example of using a part: degree of physique reliability TS=100%) in the first embodiment.

FIG. 6B illustrates the degree of physique reliability TS (example of using a part: degree of physique reliability TS=80%) in the first embodiment.

As illustrated in FIG. 6A, the physical feature points P1 to P7 each have a degree of importance. For example, the degree of importance of the physical feature point P1 is 0.25, and the degree of importance of the physical feature point P2 is 0.2.

When the detection unit 12 detects all of the physical feature points P1 to P7, the calculation unit 14 calculates that the degree of physique reliability TS is 100% (=0.25+0.2+0.25+0.05+0.05+0.1+0.1) as illustrated in FIG. 6A.

Unlike the above, when the detection unit 12 detects five physical features P1 to P5 among the seven physical feature points P1 to P7 as illustrated in FIG. 6B, the calculation unit 14 calculates that the degree of physique reliability TS is 80% (=0.25+0.2+0.25+0.05+0.05).

Instead of the above-described calculation, the calculation unit 14 may perform calculation based on the length of the part between two or more combined physical feature points, for example, the length of the shoulder width between the right shoulder and the left shoulder, the length of the sitting height from the midpoint between the right waist and the left waist to the position of the face, the length of the right arm (or the left arm) from the right shoulder (or the left shoulder) to the right wrist (or the left wrist), and the distance between both eyes.

It is desirable that the shoulder width, the sitting height, etc. described above are set to have a larger degree of importance as the correlation with the physique is stronger. For example, it is desirable that the shoulder width and the sitting height having a large influence on the physique are set to have a higher degree of importance than both arms having a small influence on the physique.

More specifically, if the degree of importance of the shoulder width is set to 0.5, the degree of importance of the length of the sitting height is set to 0.4, and the degrees of importance of both arms are set to 0.1, the degree of physique reliability TS is calculated to be 100% (=0.5+0.4+0.1) when the shoulder width, the sitting height, and both arms are all detected, and the degree of physique reliability TS is calculated to be 90% (=0.5+0.4) when, for example, the shoulder width and the sitting height are detected and both arms are not detected.

Further, the degree of importance of the physical feature point may be multiplied by the degree of certainty. For example, in a case where the degree of importance of the shoulder width is set to 0.5, and furthermore, the degree of certainty of the right shoulder is set to 0.8 and the degree of certainty of the left shoulder is set to 0.6, the degree of physique reliability TS is calculated to be 0.35 (=0.5×(0.8+0.6)/2) by multiplying the degree of importance of the shoulder width and the average of the degrees of certainty of both shoulders.

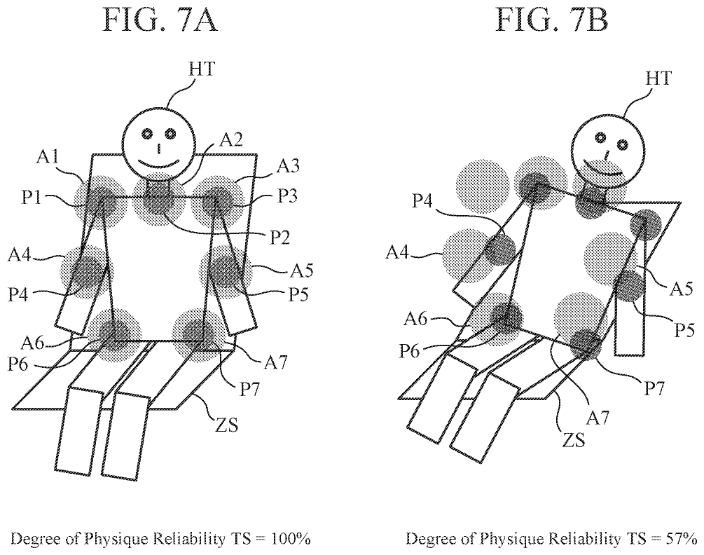

FIG. 7A illustrates the degree of physique reliability TS (example of using position: degree of physique reliability TS=100%) in the first embodiment.

FIG. 7B illustrates the degree of physique reliability TS (example of using position: degree of physique reliability TS=57%) in the first embodiment.

As illustrated in FIG. 7A, regions A1 to A7 where parts of the person HT would be located if the person HT is properly seated on the seat ZS are assumed in advance on the seat ZS. For example, the region A1 indicates that the physical feature point P1 of the right shoulder would be located in the region A1 if the person HT is properly seated on the seat ZS.

When the detection unit 12 detects that the seven physical feature points P1 to P7 overlap the seven regions A1 to A7, respectively, while the person HT is properly seated on the seat ZS as illustrated in FIG. 7A, the calculation unit 14 calculates that the degree of physique reliability TS is 100% (=7/7).

Unlike the above, when the detection unit 12 detects that four physical feature points P4, P5, P6, and P7 overlap the four regions A4, A5, A6, and A7, respectively, while the person HT is not properly seated on the seat ZS as illustrated in FIG. 7B, the calculation unit 14 calculates that the degree of physique reliability TS is about 57% (=4/7).

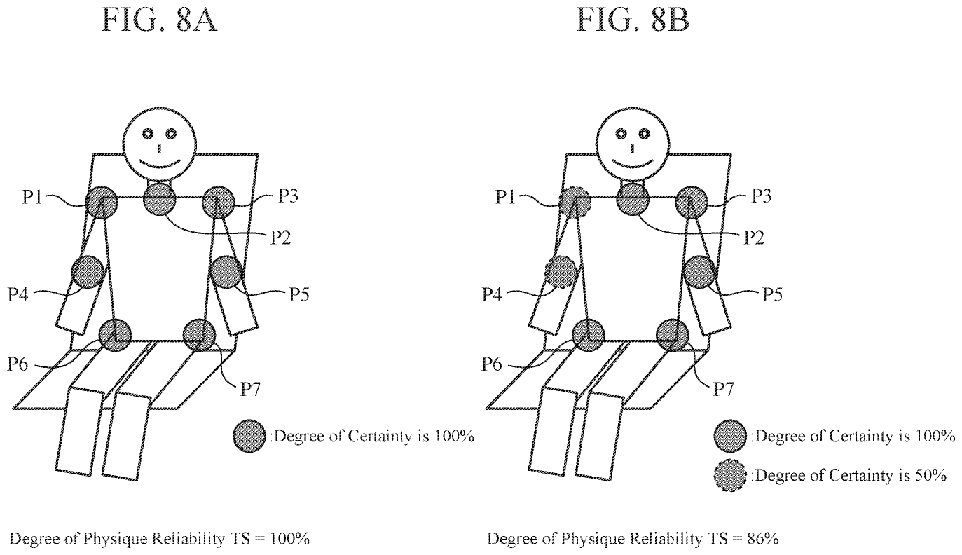

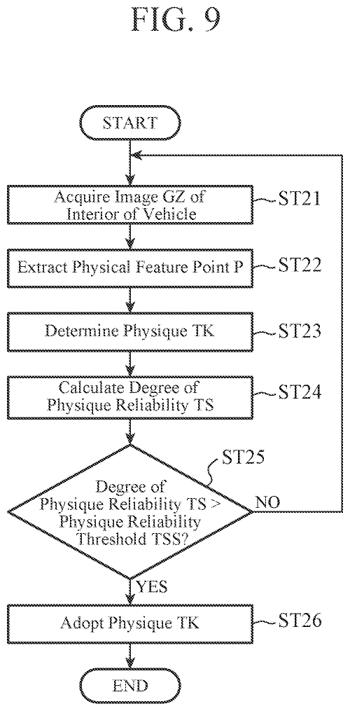

FIG. 8A illustrates the degree of physique reliability TS (example of using a degree of certainty: degree of physique reliability TS=100%) of the person HT in the first embodiment.

FIG. 8B illustrates the degree of physique reliability TS (example of using a degree of certainty: degree of physique reliability TS=86%) of the person HT in the first embodiment.

In FIGS. 8A and 8B, solid circles indicate that the physical feature point P has been detected with a high degree of certainty, while dotted circles indicate that the physical feature point has been detected with a low degree of certainty.

As illustrated in FIG. 8A, each of the physical feature points P1 to P7 should originally be detected with a high degree of certainty from the image GZ, for example, with a degree of certainty exceeding a predetermined threshold for the degree of certainty.

When the detection unit 12 detects each of the physical feature points P1 to P7 with a degree of certainty of 100%, in other words, when the degree of certainty of the physical feature point P1, the degree of certainty of the physical feature point P2, . . . and the degree of certainty of the physical feature point P7 are 100%, the calculation unit 14 calculates that the degree of physique reliability TS is 100% (=100*7/7).

In contrast to the above, when the detection unit 12 detects that, for example, the degrees of certainty of the physical feature points P2, P3, P5, P6, and P7 are 100%, and the degrees of certainty of the physical feature points P1 and P4 are 50% due to, for example, defocus of the image GZ or a part of the person HT being hidden by an obstacle (not illustrated), the calculation unit 14 calculates that the degree of physique reliability TS is about 86% (=(100*5+50*2)/7).

<Effects of First Embodiment>

As described above, in the physique determination device 10 according to the first embodiment, the determination unit 13 determines the physique TK of the person HT on the basis of the physical feature point P, and the calculation unit 14 calculates the degree of physique reliability TS of the person HT on the basis of the physical feature point P. Thus, the physique TK of the person HT can be estimated, and further, the degree of physique reliability TS of the estimated physique of the person HT can be indicated.

For the person HT, the deployment of an air bag in the automobile, for example, can be controlled according to the estimated physique TK and the calculated degree of physique reliability TS.

<First Modification>

FIG. 9 is a flowchart illustrating an operation of the physique determination device 10 according to a first modification of the first embodiment.

<Configuration and Function of First Modification>

The configuration and function of the physique determination device 10 according to the first modification are similar to the configuration and function (illustrated in FIG. 1 and FIG. 3) of the physique determination device 10 according to the first embodiment.

<Operation of First Modification>

The operation of the physique determination device 10 according to the first modification will be described with reference to the flowchart of FIG. 9.

Steps ST21 to ST24: Similar to steps ST11 to ST14 in the first embodiment, the acquisition unit 11 acquires the image GZ of the interior of the vehicle, the detection unit 12 detects the physical feature point P of the person HT, the determination unit 13 determines the physique TK of the person HT, and the calculation unit 14 calculates the degree of physique reliability TS of the person HT.

Step ST25: The assessment unit 15 assesses whether or not the degree of physique reliability TS exceeds a physique reliability threshold TSS. When it is assessed that the degree of physique reliability TS of the person HT exceeds the physique reliability threshold TSS, the processing proceeds to step ST26 through “YES”. On the other hand, when it is assessed that the degree of physique reliability TS does not exceed the physique reliability threshold TSS, the processing returns to step ST21 through “NO”. Returning to step ST21, the processing executes again, that is, repeats steps ST21 to ST24.

Step ST26: Since the degree of physique reliability TS exceeds the physique reliability threshold TSS, the adoption unit 16 adopts the reliable physique TK.

<Effects of First Modification>

In the physique determination device 10 according to the first modification, when the degree of physique reliability TS calculated by the calculation unit 14 exceeds the physique reliability threshold TSS after the acquisition by the acquisition unit 11, the detection by the detection unit 12, the determination by the determination unit 13, and the calculation by the calculation unit 14 are repeated in steps ST21 to ST24, the adoption unit 16 adopts the physique TK determined by the determination unit 13. As a result, the physique TK of the person HT can be determined with a higher degree of reliability than with the physique determination device 10 according to the first embodiment.

<Second Modification>

Instead of always performing the above determination of the physique TK of the person HT, the determination unit 13 may determine the physique TK of the person HT only when, for example, at least one of the numbers, parts, positions, or degrees of certainty of the physical feature points P1 to P7 exceed a predetermined threshold, in other words, only when the degree of physique reliability TS exceeds the physique reliability threshold TSS.

<Third Modification>

When the degree of physique reliability TS of the person HT does not exceed the physique reliability threshold TSS, the notification unit 17 desirably notifies the person HT of information indicating “indeterminable (HF)” (illustrated in FIG. 1). In response to the notification, the person HT, for example, properly sits on the seat ZS, adjusts the orientation of the body, and the like, by which the degree of physique reliability TS of the person HT can be improved.

<Fourth Modification>

When the detection unit 12 detects, for example, the physical feature points P1, P3, P6, and P7 among the physical feature points P1 to P7 but does not detect the physical feature points P1, P4, and P5, the determination unit 13 may determine the physique TK of the person HT on the basis of only the detected physical feature points P1, P3, P6, and P7.

### Second Embodiment

### Second Embodiment

Unlike the physique determination device 10 according to the first embodiment, a physique determination device 20 according to a second embodiment handles person information HJ for the same person HT in time series.

<Person Information HJ in Second Embodiment>

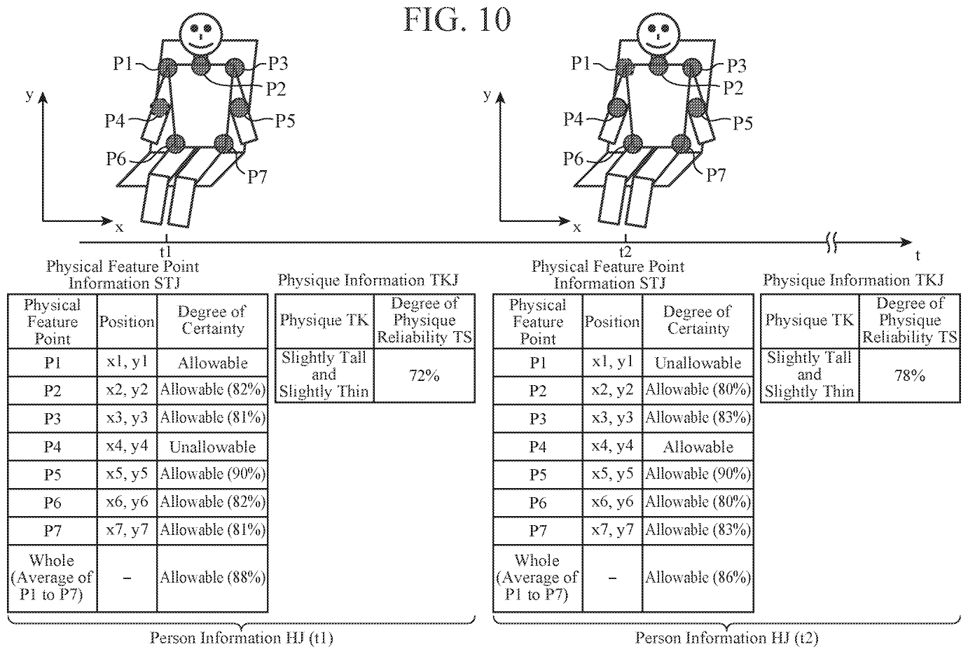

FIG. 10 illustrates person information HJ according to the second embodiment.

As illustrated in FIG. 10, the person information HJ of the person HT is acquired at each of a plurality of time points in time series, for example, at times t1, t2, etc.

The “person information HJ” includes physical feature point information STJ and physique information TKJ of the person HT as illustrated in FIG. 10.

The “physical feature point information STJ” refers to information regarding the physical feature point P of the person HT. The physical feature point information STJ includes physical feature points P1 to P7, and positions and degrees of certainty of the physical feature points P1 to P7 as illustrated in FIG. 10.

In order to improve the efficiency of the processing such as integration by the integration unit 28 (this will be described later) by reducing an information amount, the physical feature point information STJ may include only the length having a large influence on the physique, for example, only the length of the shoulder width and the length of the sitting height among the lengths of a part between the combined two or more physical feature points described in the first embodiment, instead of the physical feature points P1 to P7.

The physical feature points P1 to P7 correspond to the physical feature points P1 to P7 (illustrated in, for example, FIG. 5) of the first embodiment.

The positions are coordinate positions of the physical feature points P1 to P7.

The degree of certainty corresponds to the degree of certainty described with reference to FIG. 8 in the first embodiment. In order to facilitate the description and understanding, the degree of certainty is expressed using “allowable” indicating that the degree of certainty exceeds a predetermined threshold or “unallowable” indicating that the degree of certainty falls below the predetermined threshold, in addition to “%” (for example, 100%, 50%) in the first embodiment.

For example, at time t1, the physical feature point P1 at time t1 is reliable because the degree of certainty is “allowable”. On the other hand, the physical feature point P4 at time t1 is not necessarily reliable because the degree of certainty is “unallowable”.

In contrast, at time t2, the physical feature point P1 at time t2 is not necessarily reliable because the degree of certainty is “unallowable”. On the other hand, the physical feature point P4 at time t2 is reliable because the degree of certainty is “allowable”.

The “physique information TKJ” refers to information regarding the physique of the person HT.

The physique information TKJ includes a physique TK and a degree of physique reliability TS.

The physique TK corresponds to the physique TK in the first embodiment. The degree of physique reliability TS corresponds to the degree of physique reliability TS in the first embodiment. For example, the degree of physique reliability TS of “72%” at time t1 is different from the degree of certainty of “88%” of the whole physical feature point (average of P1 to P7). This is because the degree of physique reliability TS of “72%” is calculated, for example, in consideration of the part (illustrated in FIG. 6) and the position (illustrated in FIG. 7) of the physical feature point in addition to being based on the degree of certainty of “88%” of the physical feature point.

<Function of Second Embodiment>

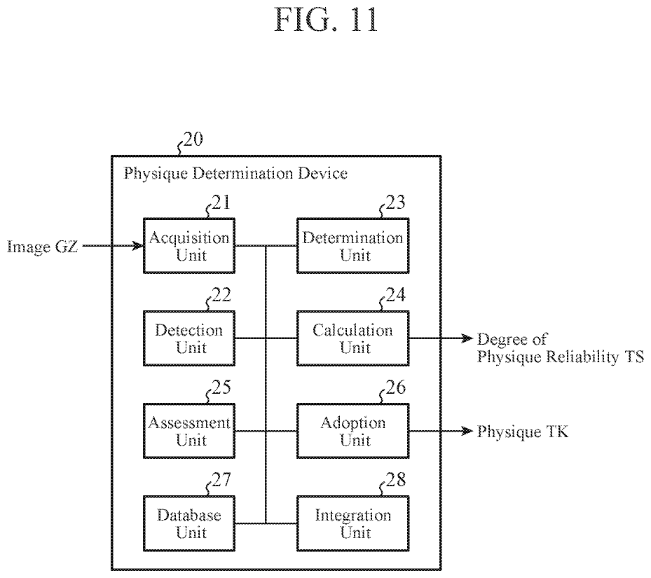

FIG. 11 is a functional block diagram of the physique determination device 20 according to the second embodiment. The function of the physique determination device 20 according to the second embodiment will be described below with reference to FIG. 11.

Similar to the physique determination device 10 according to the first embodiment, the physique determination device 20 according to the second embodiment includes an acquisition unit 21, a detection unit 22, a determination unit 23, a calculation unit 24, an assessment unit 25, and an adoption unit 26.

On the other hand, unlike the physique determination device 10 according to the first embodiment, the physique determination device 20 according to the second embodiment further includes a database unit 27 and an integration unit 28.

The acquisition unit 21 corresponds to the “acquisition unit”, the detection unit 22 corresponds to the “detection unit”, the determination unit 23 corresponds to the “determination unit”, the calculation unit 24 corresponds to the “calculation unit”, the assessment unit 25 corresponds to the “assessment unit”, the adoption unit 26 corresponds to the “adoption unit”, the database unit 27 corresponds to a “database unit”, and the integration unit 28 corresponds to an “integration unit”.

The functions of the acquisition unit 21, the detection unit 22, the determination unit 23, the calculation unit 24, the assessment unit 25, and the adoption unit 26 of the second embodiment are similar to the functions of the acquisition unit 11, the detection unit 12, the determination unit 13, the calculation unit 14, the assessment unit 15, and the adoption unit 16 of the first embodiment.

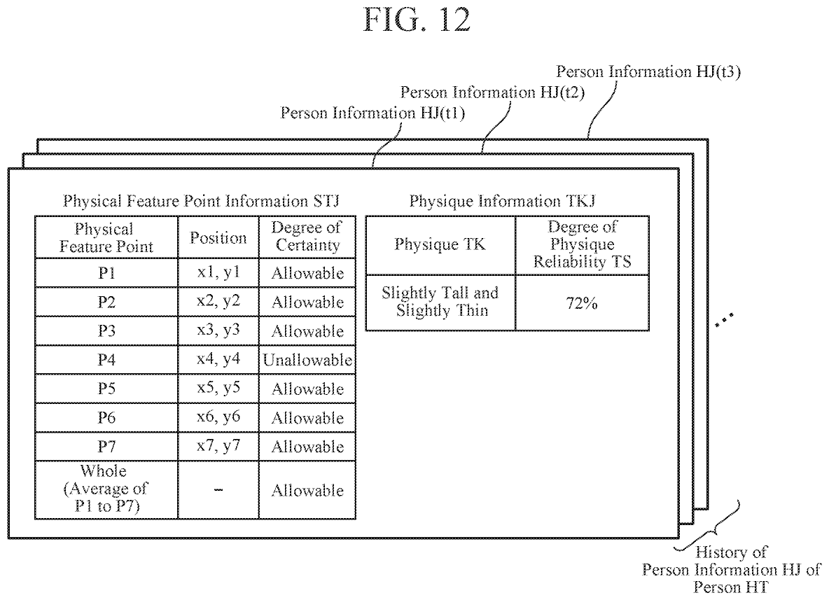

FIG. 12 illustrates the history of the person information HJ according to the second embodiment.

The database unit 27 stores histories of, for example, person information HJ(t1), person information HJ(t2), and person information HJ(t3) which are person information at times t1, t2, and t3 as illustrated in FIG. 12.

Returning to FIG. 11, the function of the physique determination device 20 will be described.

The integration unit 28 integrates the person information HJ at a plurality of time points in time series. For example, the integration unit 28 integrates the physical feature points P1 to P7 (illustrated in FIG. 10) of the person information HJ(t1) which is the person information HJ at time t1, and the physical feature points P1 to P7 (illustrated in FIG. 10) of the person information HJ(t2) which is the person information HJ at time t2.

<Configuration of Second Embodiment>

The configuration of the physique determination device 20 according to the second embodiment is similar to the configuration (illustrated in FIG. 3) of the physique determination device 10 according to the first embodiment.

<Operation of Second Embodiment>

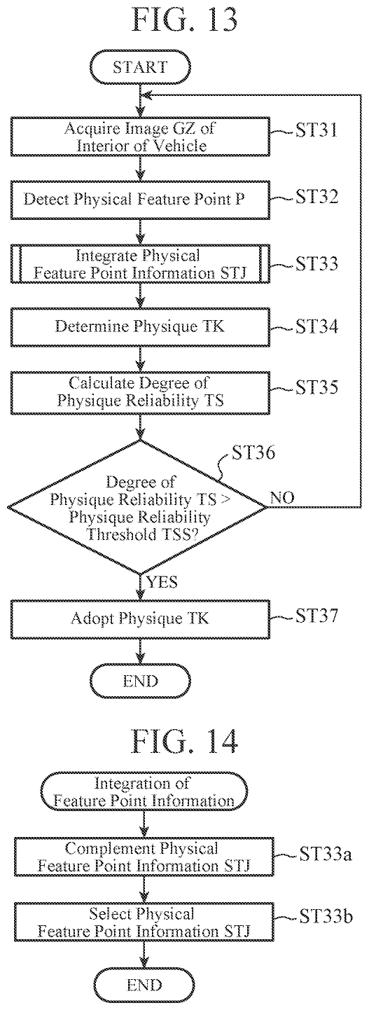

FIG. 13 is a flowchart (main routine) illustrating an operation of the physique determination device 20 according to the second embodiment.

FIG. 14 is a flowchart (sub routine) illustrating the operation of the physique determination device 20 according to the second embodiment.

The operation of the physique determination device 20 according to the second embodiment will be described with reference to the flowcharts of FIGS. 13 and 14.

For ease of description and understanding, the operation will be described based on the following conditions.

(1) The current time is “time t3”.

(2) The degree of physique reliability TS in the person information HJ at time t1 is “72%” (illustrated in FIG. 10).

(3) The degree of physique reliability TS in the person information HJ at time t2 is “78%” (illustrated in FIG. 10).

(4) The person information HJ(t1) and the person information HJ(t2) which are the person information HJ at times t1 and t2 are stored in the database unit 27.

(5) When the degree of physique reliability TS exceeds the physique reliability threshold TSS, the physique TK is adopted as in the first modification of the first embodiment.

(6) The numerical values of the degrees of certainty for the physical feature points P1 and P4 are not written in order to simplify the description.

Steps ST31 and ST32: When time t3 has come while the physique TK at time t1 and the physique TK at time t2 are not adopted as a result that the degree of physique reliability TS of “72%” at time t1 does not exceed “80%” which is the physique reliability threshold TSS and the degree of physique reliability TS of “78%” at time t2 does not exceed “80%” which is the physique reliability threshold TSS, the acquisition unit 11 acquires the image GZ of the interior of the vehicle, and the detection unit 12 detects at least one of the physical feature points P1 to P7 from the image GZ, as in steps ST21 and ST22 in the first modification of the first embodiment.

Step ST33: The integration unit 28 integrates the person information HJ at a plurality of time points in time series so as to complement the person information HJ each other. The integration unit 28 integrates the person information HJ(t1) and the person information HJ(t2) (both are illustrated in FIG. 10) stored in the database unit 27 and adjacent to each other in time series, for example. More specifically, the integration unit 28 adopts one that can be more reliable among the physical feature points P1 to P7 at time t1 and the physical feature points P1 to P7 at time 2 on the basis of (A) whether the degrees of certainty of the physical feature points P1 to P7 are “allowable” or “unallowable”, (B) when the degree of certainty is “allowable”, which time the degree of certainty is large, (C) which time the degree of certainty as a whole (average of P1 to P7) is large, (D) which time the degree of physique reliability TS is large, and the like.

For example, the integration unit 28 adopts the person information HJ(t1) at time t1 and the person information HJ(t2) at time t2 by the following complement or selection. Here, in particular, the “complement” means that, when, for example, a physical feature point Px (x is any integer) at time tq (q is any integer) is “unallowable”, the physical feature point Px that is “allowable” at time tp (p is an integer smaller than q) preceding the time tq or the physical feature Px that is “allowable” at time tr (r is an integer larger than q) following the time tq is used instead of the physical feature point Px at time tq.

(1) Physical Feature Point P1

The physical feature point P1 at time t2 that is “unallowable” is complemented with the physical feature point P1 at time t1 that is “allowable” (step ST33a).

(2) Physical Feature Point P2

The physical feature point P2 at time t1 having the degree of certainty of “82%” greater than the degree of certainty of “80%” at time t2 is selected (step ST33b).

(3) Physical Feature Point P3

The physical feature point P3 at time t2 having the degree of certainty of “83%” greater than the degree of certainty of “81%” at time t1 is selected.

(4) Physical Feature Point P4

The physical feature point P4 at time t1 that is “unallowable” is complemented with the physical feature point P4 at time t2 that is “allowable” (step ST33a).

(5) Physical Feature Point P5

(5-1) when Emphasis is Placed on the Degree of Certainty of the Whole Physical Feature Point

The physical feature point P5 at time t1 having the degree of certainty of “88%” greater than the degree of certainty of “86%” at time t2 is selected (step ST33b).

(5-2) When Emphasis is Placed on the Degree of Physique Reliability TS

The physical feature point P5 at time t2 having the degree of physique reliability TS of “78%” greater than the degree of physique reliability TS of “72%” at time t1 is selected (step ST33b).

(6) Physical Feature Point P6

The physical feature point P6 at time t1 having the degree of certainty of “82%” greater than the degree of certainty of “80%” at time t2 is selected (step ST33b).

(7) Physical Feature Point P7

The physical feature point P7 at time t2 having the degree of certainty of “83%” greater than the degree of certainty of “81%” at time t1 is selected (step ST33b).

The integration unit 28 may use, for example, a result of inference obtained from machine learning by inputting the person information HJ(t1), HJ(t2), and the like instead of the above-described complement and selection.

Step ST34: The processor PC (illustrated in FIG. 3) determines, as the determination unit 23 (illustrated in FIG. 11), the physique TK of the person HT on the basis of the person information HJ obtained by integrating the person information HJ(t1) and the person information HJ(t2), more precisely, the physical feature points P1 to P7 of (1) to (7) described above.

Step ST35: The processor PC calculates, as the calculation unit 24 (illustrated in FIG. 11), the degree of physique reliability TS of the person HT on the basis of the person information HJ obtained by integrating the person information HJ(t1) and the person information HJ(t2), more precisely, the physical feature points P1 to P7 of (1) to (7) described above. Thus, the degree of physique reliability TS calculated on the basis of the physical feature points P1 to P7 after the integration is expected to exceed “80%” which is the physique reliability threshold TSS. Here, it is supposed that the degree of physique reliability TS is improved from “72%” at time t1 and “78%” at time t2 to, for example, “85%”.

Step ST36: The processor PC assesses, as the assessment unit 25 (illustrated in FIG. 11), whether or not the degree of physique reliability TS exceeds the physique reliability threshold TSS as in the first modification of the first embodiment. When it is assessed that the degree of physique reliability TS exceeds the physique reliability threshold TSS, the processing proceeds to step ST37 through “YES”. On the other hand, when it is assessed that the degree of physique reliability TS does not exceed the physique reliability threshold TSS, the processing returns to step ST31 through “NO”, and repeats steps ST31 to ST35.

Here, the degree of physique reliability TS of “85%” of the person HT exceeds “80%” that is the physique reliability threshold TSS, and thus, the processing proceeds to step ST37.

Step ST37: As in the first modification of the first embodiment, the adoption unit 26 adopts the physique TK that is reliable.

<Effects of Second Embodiment>

As described above, in the physique determination device 20 according to the second embodiment, the integration unit 28 integrates, for example, the person information HJ(t1) and the person information HJ(t2) to make the timing at which the degree of physique reliability TS exceeds the physique reliability threshold TSS earlier. As a result, the number of times the acquisition by the acquisition unit 21, the detection by the detection unit 22, the determination by the determination unit 23, and the calculation by the calculation unit 24 are repeated can be reduced as compared with the first modification of the first embodiment.

<First Modification>

Unlike the assumption described above, in a case where the degree of physique reliability TS after the integration is not improved to “85%” beyond the physique reliability threshold TSS of “80%” in step ST35 described above, but is improved to, for example, “79%”, and thus the degree of physique reliability TS of “79%” does not exceed the physique reliability threshold TSS of “85%”, the adoption unit 26 may adopt the physique TK corresponding to the larger degree of physique reliability TS out of the physique TK in the person information HJ(t1) and the physique TK in the person information HJ(t2).

Instead of the above, the adoption unit 26 may, for example, adopt the physique TK corresponding to the largest degree of physique reliability TS out of the physique TK in the person information HJ(t1), the physique TK in the person information HJ(t2), and the physique TK in the person information HJ(t3) at time t4.

When, for example, the degree of physique reliability TS of “78%” of the person information HJ(t2) is the largest among, for example, the degree of physique reliability TS in the person information HJ(t1), the degree of physique reliability TS in the person information HJ(t2), and the degree of physique reliability TS in the person information HJ(t3), the adoption unit 26 may adopt the physique TK of “slightly tall and slightly thin” in the person information HJ(t2).

In addition to integrating, at time t3, the two pieces of person information HJ(t1) and HJ(t2) at times preceding time t3, the adoption unit 26 may integrate, at time t4, the three pieces of person information HJ(t1), HJ(t2), and HJ(t3) at times preceding time t4, and integrate, at time t5, the four pieces of person information HJ(t1), HJ(t2), HJ(t3), and HJ(t4) at times preceding time t5, for example.

<Second Modification>

When a situation in which the degree of physique reliability TS does not exceed “80%” which is the physique reliability threshold TSS continues, and the same physique TK continues, the adoption unit 26 may adopt the physique TK without performing the integration described above. Specifically, when, for example, the degree of physique reliability TS of the person information HJ(t1) is “72%” (illustrated in FIG. 10), the degree of physique reliability TS of the person information HJ(t2) is “78%” (illustrated in FIG. 10), and the degree of physique reliability TS of the person information HJ(t3) is “75%” (not illustrated), and the same physique TK of “slightly tall and slightly thin” continues, the adoption unit 26 may adopt the physique TK of “slightly tall and slightly thin”, although all of the degrees of physique reliability TS of “72%”, “78%” and “75%” do not exceed the physique reliability threshold TSS of “80%”. With this configuration, the number of times the acquisition by the acquisition unit 21, the detection by the detection unit 22, the determination by the determination unit 23, and the calculation by the calculation unit 24 are repeated can also be reduced as in the second embodiment.

### Third Embodiment

### Third Embodiment

Unlike the physique determination device 20 according to the second embodiment, a physique determination device 30 according to a third embodiment handles personal feature information HTJ for a plurality of different persons.

<Personal Feature Information HTJ of Third Embodiment>

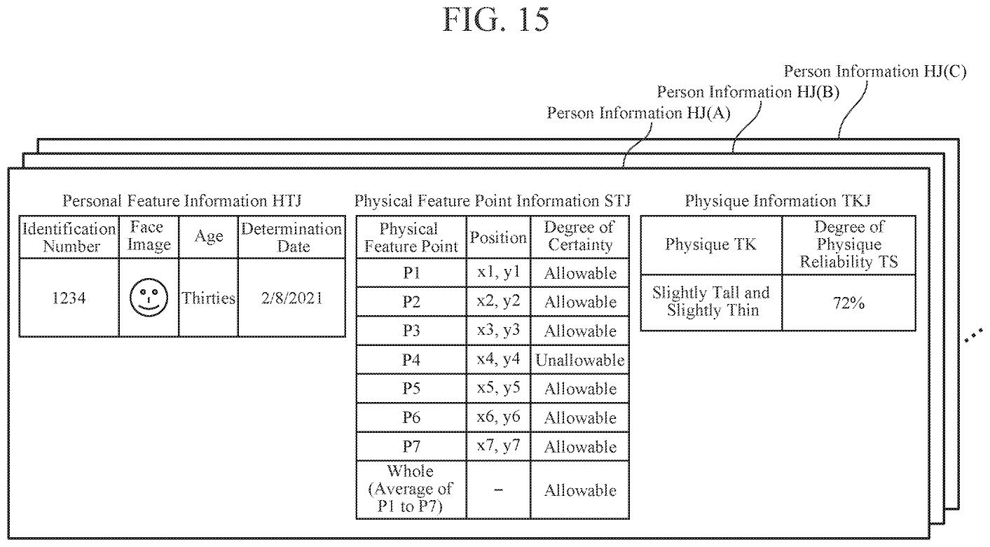

FIG. 15 illustrates personal feature information HTJ according to the third embodiment.

In the third embodiment, for example, person information HJ(A), person information HJ(B), and person information HJ(C) which are person information HJ for a plurality of different persons A, B, and C (not illustrated) are used as illustrated in FIG. 15.

The person information HJ in the third embodiment includes physical feature point information STJ and physique information TKJ as with the person information HJ (illustrated in FIG. 12) in the second embodiment. On the other hand, unlike the person information HJ in the second embodiment, the person information HJ in the third embodiment further includes personal feature information HTJ.

The “personal feature information HTJ” includes an identification number, a face image, an age, and a determination date as illustrated in FIG. 15. The identification number is a number assigned in advance to each person such as a person A, a person B, or a person C to identify him/her from another person. The face image is a front face, a side face, or the like of the person such as the person A, B, or C. The age is, more precisely, an age group such as thirties and forties. The determination date is the date on which the physique TK of each person such as the person A, B, or C has been determined, for example, Feb. 8, 2021.

<Function of Third Embodiment>

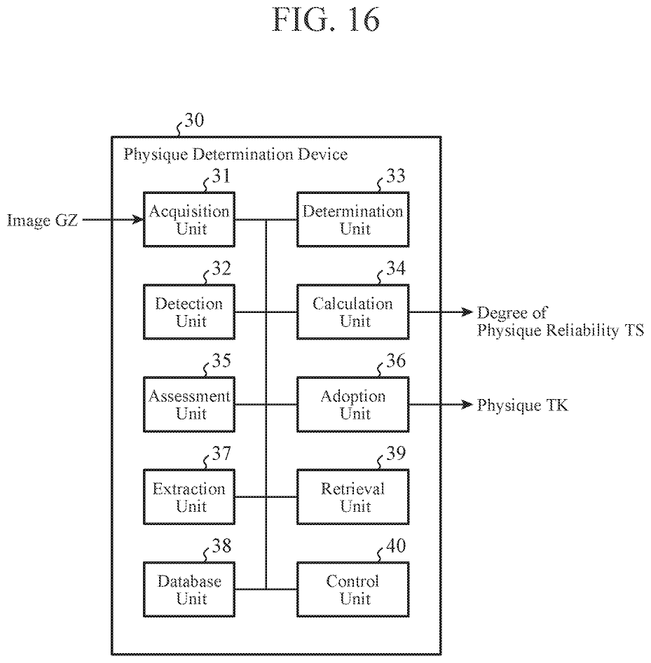

FIG. 16 is a functional block diagram of the physique determination device 30 according to the third embodiment. The function of the physique determination device 30 according to the third embodiment will be described below with reference to FIG. 16.

Similar to the physique determination device 10 according to the first embodiment, the physique determination device 30 according to the third embodiment includes an acquisition unit 31, a detection unit 32, a determination unit 33, a calculation unit 34, an assessment unit 35, and an adoption unit 36.

On the other hand, unlike the physique determination device 10 according to the first embodiment, the physique determination device 30 according to the third embodiment includes an extraction unit 37, a database unit 38, a retrieval unit 39, and a control unit 40.

The extraction unit 37 extracts face images of, for example, a plurality of persons A, B, and C from an image GZ (not illustrated), which is similar to the image GZ (illustrated in FIG. 2) of the interior of the vehicle, of the interior of the vehicle obtained by imaging the plurality of persons A, B, and C.

The face images are images for identifying the plurality of persons A, B, and C.

The face image corresponds to a “personal feature”.

The database unit 38 stores the person information HJ(A), HJ(B), and HJ(C) of the plurality of persons A, B, and C, and more specifically stores the physical feature point information STJ and the physique information TKJ in association with the personal feature information HTJ, as illustrated in FIG. 15.

The retrieval unit 39 retrieves the physiques TK of the persons A, B, and C by referring to the database unit 38 on the basis of the face images extracted by the extraction unit 37.

The control unit 40 decreases the degrees of physique reliability TS in the person information HJ(A), HJ(B), and HJ(C) of the plurality of persons A, B, and C stored in the database unit 38 over time, and deletes the physiques TK of the plurality of persons A, B, and C when a predetermined time has elapsed from a time point related to the calculation of the degrees of physique reliability TS of the plurality of persons A, B, and C.

<Configuration of Third Embodiment>

The configuration of the physique determination device 30 according to the third embodiment is similar to the configuration (illustrated in FIG. 3) of the physique determination device 10 according to the first embodiment.

<Operation of Third Embodiment>

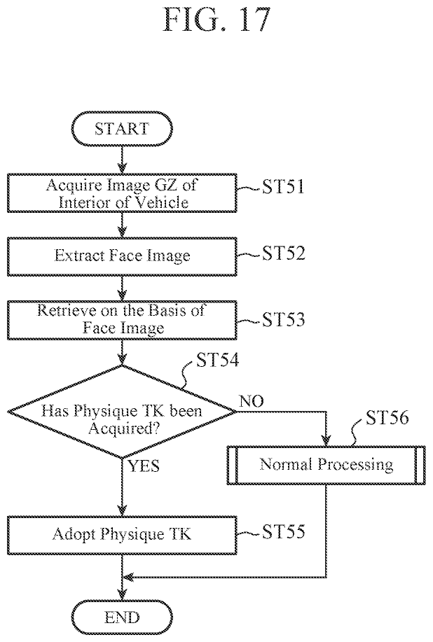

FIG. 17 is a flowchart illustrating an operation of the physique determination device 30 according to the third embodiment. The operation of the physique determination device 30 according to the third embodiment will be described with reference to the flowchart of FIG. 17.

For ease of description and understanding, the operation will be described based on the following conditions.

(1) The physique TK of the person A is determined.

(2) The person information HJ(A) of the person A is stored in the database unit 38 without deletion of the physique TK of the person A.

Step ST51: The processor PC (illustrated in FIG. 3) acquires, as the acquisition unit 31 (illustrated in FIG. 16), the image GZ (not illustrated) of the interior of, for example, the automobile in which the person A is seated on the seat ZS, as in step ST11 in the first embodiment.

Step ST52: The processor PC extracts, as the extraction unit 37 (illustrated in FIG. 16), a face image from the acquired image GZ of the person A.

Step ST53: The processor PC retrieves, as the retrieval unit 39 (illustrated in FIG. 16), the person information HJ(A) of the person A by referring to the database unit 38 on the basis of the extracted face image of the person A. Here, since the face image of the person A acquired by the acquisition unit 31 matches the face image in the person information HJ(A) (illustrated in FIG. 15) of the person A stored in the database unit 38, the retrieval unit 39 acquires the physique TK of the person A from the person information HJ(A) of the person A.

Step ST54: The processor PC assesses, as the assessment unit 35 (illustrated in FIG. 16), whether or not the retrieval unit 39 has been able to retrieve the physique TK of the person A from the database unit 38, that is, whether or not the physique TK of the person A has been able to be acquired. It is assessed that the retrieval unit 39 has been able to acquire the physique TK of the person A, and thus, the processing proceeds to step ST55 through “YES”.

If it is determined that the physique TK of the person A has not been acquired, the processing proceeds to step ST56 through “NO”.

Step ST55: The processor adopts, as the adoption unit 36 (illustrated in FIG. 16), the physique TK of the person A acquired by the retrieval unit 39.

Step ST56: The processor PC performs normal processing, for example, the processing of the first embodiment (illustrated in FIGS. 4 and 9). Accordingly, the physique TK and the degree of physique reliability TS of the person A can be obtained as in the first embodiment.

<Effects of Third Embodiment>

In the physique determination device 30 according to the third embodiment, the retrieval unit 39 retrieves the person information HJ(A) of the person A including the physique TK by referring to the database unit 38 on the basis of the face image of the person A extracted by the extraction unit 37. As a result, unlike the physique determination device 10 according to the first embodiment, the physique determination device 30 according to the third embodiment can obtain the physique TK of the person A without performing the detection of the physical feature point by the detection unit 32, the determination of the physique TK by the determination unit 33, and the calculation of the degree of physique reliability TS by the calculation unit 34, and can also obtain the degree of physique reliability TS as necessary.

<First Modification>

Instead of always adopting the physique TK of the person A included in the person information HJ(A) of the person A, the adoption unit 36 may adopt the physique TK only when the degree of physique reliability TS of the person A included in the person information HJ(A) of the person A exceeds “80%” that is the physique reliability threshold TSS, for example.

<Second Modification>

It is desirable that the control unit 40 desirably decreases, over time, the degree of physique reliability TS of the person A, B, or C stored in the database unit 38, and deletes the physique TK of the person A, B, or C from the database unit 38 when a predetermined time (for example, one year, three years, or five years) has elapsed from a time point related to the calculation of the degree of physique reliability TS of the person A, B, or C, for example, from a time point at which the image GZ of the person A, B, or C has been acquired or a time point at which the physique TK of the person A, B, or C has been determined (determination date). This configuration can avoid a situation in which, for example, the retrieval unit 39 erroneously acquires the person information HJ(B) of the person B, although it should originally acquire the person information HJ(A) of the person A due to, for example, a temporal change in the actual faces of the persons A, B, and C.

The predetermined time described above desirably differs depending on, for example, the ages of the persons A, B, and C. For example, the predetermined time is set to one year for a teenager that would have a noticeable physical change, and set to five years for an elderly person that would have less physical change.

Components in the embodiments may be appropriately removed or changed, or another component may be added without departing from the gist of the present disclosure.

### INDUSTRIAL APPLICABILITY

The physique determination device according to the present disclosure can be used, for example, to determine the physique of a person riding in an automobile.

### REFERENCE SIGNS LIST

10: physique determination device, 11: acquisition unit, 12: detection unit, 13: determination unit, 14: calculation unit, 15: assessment unit, 16: adoption unit, 17: notification unit, 20: physique determination device, 21: acquisition unit, 22: detection unit, 23: determination unit, 24: calculation unit, 25: assessment unit, 26: adoption unit, 27: database unit, 28: integration unit, 30: physique determination device, 31: acquisition unit, 32: detection unit, 33: determination unit, 34: calculation unit, 35: assessment unit, 36: adoption unit, 37: extraction unit, 38: database unit, 39: retrieval unit, 40: control unit, A: person, A1: region, A2: region, A3: region, A4: region, A5: region, A6: region, A7: region, B: person, C: person, DB: database, GZ: image, HF: indeterminable, HJ: person information, HT: person, HTJ: personal feature information, KB: storage medium, MM: memory, NB: input unit, PC: processor, P1 to P7: physical feature point, Pa to Pn: physical feature point, PR: program, SB: output unit, STJ: physical feature point information, TK: physique, TKJ: physique information, TS: degree of physique reliability, TSS: physique reliability threshold, ZS: seat

1.-15. (canceled)

16. A physique determination device comprising processing circuitry
to perform acquisition of an image of a person,
to perform detection, from the image that is acquired, of at least one of a plurality of physical feature points of the person,
to perform determination, on a basis of the at least one of the plurality of physical feature points that is detected, of a physique of the person,
to perform calculation, on a basis of the at least one of the plurality of physical feature points that is detected, of a degree of reliability of the physique of the person that is determined, and
to perform generation of an integrated physical feature point by integrating the plurality of physical feature points of the person detected at a plurality of time points and perform generation of an integrated physique of the person by integrating physiques of the person determined at the plurality of time points, each of which is the physique of the person, among the plurality of time points, wherein
the processing circuitry performs the determination and the calculation on a basis of the integrated physical feature point and the integrated physique of the person.

17. The physique determination device according to claim 16, wherein the processing circuitry performs to adopt the physique of the person when the degree of reliability of the integrated physique of the person exceeds a predetermined reliability threshold when the acquisition, the detection, the determination, the calculation, and the generation of the integrated physical feature point and the generation of the integrated physique are repeated.

18. The physique determination device according to claim 17, wherein, when the degree of reliability of the physique calculated on a basis of the integrated physical feature point and the integrated physique does not exceed the reliability threshold, the processing circuitry adopts the physique of the person corresponding to the largest degree of reliability of the physique or the physique of the person which has been continuously determined to be a same physique among the physiques determined at the plurality of time points.

19. The physique determination device according to claim 16, wherein the processing circuitry performs to store the physical feature points detected at the plurality of time points and the physiques of the person determined at the plurality of time points.

20. The physique determination device comprising processing circuitry
to perform acquisition of an image of a person;
to perform detection, from the image that is acquired, of at least one of a plurality of physical feature points of the person;
to perform determination, on a basis of the at least one of the plurality of physical feature points that is detected, of a physique of the person;
to perform calculation, on a basis of the at least one of the plurality of physical feature points that is detected, of a degree of reliability of the physique of the person that is determined;
to store a plurality of physical feature points, a plurality of physiques, and degrees of reliability of the plurality of physiques for a plurality of persons and a plurality of personal features for respectively identifying the plurality of persons in a database in association with each other;
to extract a personal feature of the person from the image that is acquired;
to retrieve the physique of the person by referring to the database on a basis of the personal feature of the person that is extracted;
to adopt the physique that is retrieved; and
to decrease, over time, the degrees of reliability of physiques of the plurality of persons stored in the database and to delete the physiques of the plurality of persons when a predetermined time has elapsed from a time point related to the calculation of the degrees of reliability of the physiques of the plurality of persons.

21. The physique determination device according to claim 20, wherein the predetermined time differs according to ages of the plurality of persons.

22. A physique determination method comprising:
perform acquisition of an image of a person;
perform detection, from the image that is acquired, of at least one of a plurality of physical feature points of the person;
perform determination, on a basis of the at least one of the plurality of physical feature points that is detected, of a physique of the person;
perform calculation, on a basis of the at least one of the plurality of physical feature points that is detected, of a degree of reliability of the physique of the person that is determined; and
perform generation of an integrated physical feature point by integrating the plurality of physical feature points of the person detected at a plurality of time points and perform generation of an integrated physique of the person by integrating physiques of the person determined at the plurality of time points, each of which is the physique of the person, among the plurality of time points, wherein
the processing circuitry performs the determination and the calculation on a basis of the integrated physical feature point and the integrated physique of the person.

23. A physique determination method comprising:
perform acquisition of an image of a person;
perform detection, from the image that is acquired, of at least one of a plurality of physical feature points of the person;
perform determination, on a basis of the at least one of the plurality of physical feature points that is detected, of a physique of the person;
perform calculation, on a basis of the at least one of the plurality of physical feature points that is detected, of a degree of reliability of the physique of the person that is determined, the calculation being performed;
perform storing, in a database, of a plurality of physical feature points, a plurality of physiques, and degrees of reliability of the plurality of physiques for a plurality of persons and a plurality of personal features for respectively identifying the plurality of persons in association with each other;
perform extraction of a personal feature of the person from the image that is acquired;
perform retrieve of the physique of the person by referring to the database on a basis of the personal feature of the person that is extracted;
perform adoption of the physique that is retrieved; and
perform control, over time, of the degrees of reliability of physiques of the plurality of persons stored in the database and to delete the physiques of the plurality of persons when a predetermined time has elapsed from a time point related to the calculation of the degrees of reliability of the physiques of the plurality of persons.
